(19) United States
(12) Patent Application Publication
(10) Pub. No.: US 2008/0027930 A1
(43) Pub. Date: Jan. 31, 2008

(54) Methods and apparatus for contextual schema mapping of source documents to target documents

(76) Inventors: Philip L. Bohannon, Cupertino, CA (US); Wenfei Fan, Somerset, NJ (US); Michael E. Flaster, Tenafly, NJ (US)

Correspondence Address: Ryan, Mason & Lewis, LLP;Suite 205, 1300 Post Road, Fairfield, CT, 06824, US

(21) Appl. No.: 11/496,271

(22) Filed: Jul. 31, 2006

(51) Int. Cl. G06F 17/30

(52) U.S. Cl. 707/6

(57) ABSTRACT

Methods and apparatus are provided for improved schema mapping of source documents to target documents. A list of matches are generated between at least one source table and at least one target table. One or more of the matches are annotated with a logical condition providing a context in which the match applies. Matches can be annotated with a logical condition, for example, by generating a set of candidate view conditions, C, to be applied to the one or more source tables. A schema match algorithm can generate the list of matches. Candidate logical conditions can be identified, for example, by (i) creating a set of views for categorical attributes in the tables and adding a view for each partitioning of the attribute values; (ii) using a classifier built on target attribute values; or (iii) evaluating internal features of a source table.

### FIELD OF THE INVENTION

The present invention relates to the mapping of source documents to target documents and, more particularly, to methods and apparatus for the contextual mapping of source documents to target documents.

### BACKGROUND OF THE INVENTION

A schema mapping is a data transformation that, given an instance conforming to a source schema, will produce an instance that conforms to a target schema while preserving the appropriate information content of the source. Finding schema mappings is a common task in a wide variety of data exchange and integration scenarios. A schema matching is a pairing of attributes (or groups of attributes) from the source schema and attributes of the target schema such that pairs are likely to be semantically related. In many systems, finding such a schema matching is an early step in building a schema mapping. Even with some availability of domain expertise, however, the computation of a schema matching may not be easy since the task itself may be large, involving dozens of tables and thousands of attributes. The combined effort of understanding an unfamiliar schema and matching it to another schema is a substantial burden.

As a result, automated support for schema matching has received a great deal of attention in the research community. See, for example, E. Rahm and P. A. Bernstein, “A Survey of Approaches to Automatic Schema Matching,” Very Large Database (VLDB) Journal, 2001. In state-of-the-art schema matching systems, schema matches are discovered by considering a wide variety of evidence that may indicate a match, including similarity of data, similarity of schema and metadata information, preservation of constraints, and transitive similarity based on other known mappings. Once verified by the user, matches discovered by the schema matching process constitute a key input to the creation of schema mappings. In particular, the matches form the basis of constraints that should be upheld by a mapping. A valid mapping from source to target instances ensures that these constraints are enforced.

While such schema matching techniques permit data exchange and integration between source and target data sources, they suffer from a number of limitations, which if overcome, could further improve their utility. In particular, there are many cases where such matchings fail to capture information critical to the construction of a schema.

A need therefore exists for methods and apparatus for improved schema mapping.

### SUMMARY OF THE INVENTION

Generally, methods and apparatus are provided for improved schema mapping of source documents to target documents. According to one aspect of the invention, at least one source table is mapped to at least one target table. A list of matches are generated between the at least one source table and the at least one target table. One or more of the matches are annotated with a logical condition providing a context in which the match applies. The matches can be annotated with a logical condition, for example, by generating a set of candidate view conditions, C, to be applied to the one or more source tables, wherein the candidate view conditions, C, provide the context in which a corresponding match applies. The contextual matches are evaluated based on the candidate view conditions, C. A schema match algorithm can generate the list of matches.

According to another aspect of the invention, candidate logical conditions can be identified, for example, by (i) creating a set of views for categorical attributes in the tables and adding a view for each partitioning of the values of the attributes in the tables; (ii) using a classifier built on target attribute values; or (iii) evaluating internal features of a source table to identify candidate logical conditions by rating one or more attributes on an ability of the one or more rated attributes to classify values of other attributes. According to further aspects of the invention, one or more contextual key-foreign key constraints can be inferred using rules based on the nature of the view. In addition, a plurality of mappings involving attribute normalization can be automatically generated.

A more complete understanding of the present invention, as well as further features and advantages of the present invention, will be obtained by reference to the following detailed description and drawings.

### BRIEF DESCRIPTION OF THE DRAWINGS

FIG. 1 illustrates a number of exemplary retail inventory tables containing source and target instances;

FIG. 2 illustrates a traditional schema match for the inventory, books and music of FIG. 1;

FIG. 3 illustrates a contextual schema match for the inventory, books and music of FIG. 1 in accordance with the present invention;

FIG. 4 supplement the [symbol] _{S} table of FIG. 1 with an [symbol] _{S}.price table;

FIG. 5 illustrates exemplary pseudo code for an overall approach to finding contextual matches in accordance with the present invention;

FIG. 6 illustrates exemplary pseudo code for finding good candidate conditions; and

FIG. 7 illustrates exemplary pseudo code for creating target classifiers.

### DETAILED DESCRIPTION

The present invention provides methods and apparatus for contextual schema mapping of source documents to target documents.

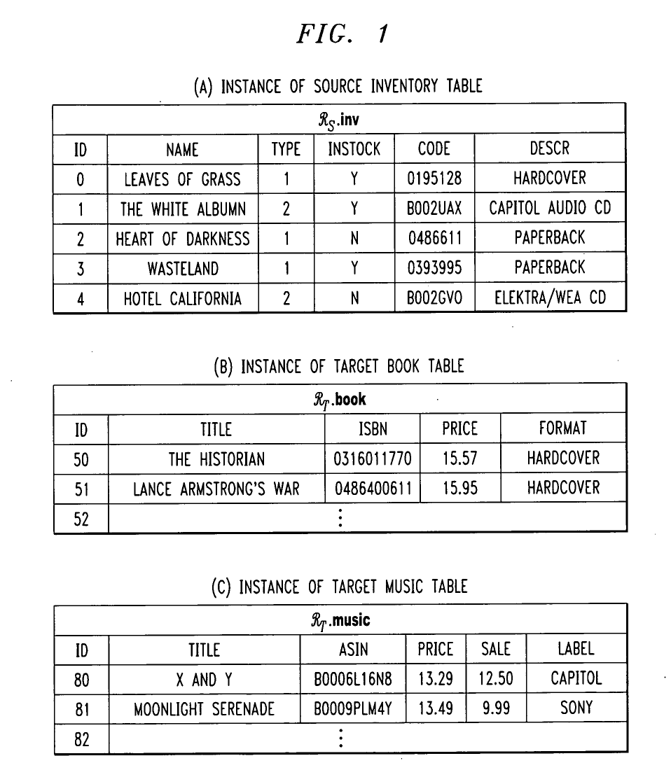

As previously indicated, there are many cases where schema matching techniques fail to capture information critical to the construction of a schema mapping. FIG. 1 illustrates a number of exemplary retail inventory tables containing source and target instances. Consider the problem of finding a mapping between schemas [symbol] _{S} and [symbol] _{T} for the retail inventory tables shown in FIG. 1. In the source table [symbol] _{S}.inv, information about books and CDs being sold by “Company S” is provided, and a type field indicates whether the object is a book or music. In the target schema, for “Company T”, information about books and music are stored in separate tables.

### Schema Matching

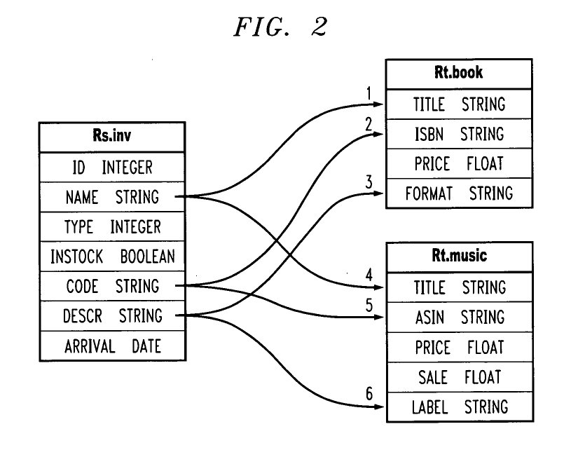

FIG. 2 illustrates a traditional schema match for the inventory, books and music of FIG. 1. A traditional schema matching system might give a subset of the matches (numbered 1-6) between [symbol] _{S} and [symbol] _{T} shown in FIG. 2. While this set of matches can form the basis of a schema mapping, it is ambiguous and clearly does not help the user discover the semantic distinction between the two target tables.

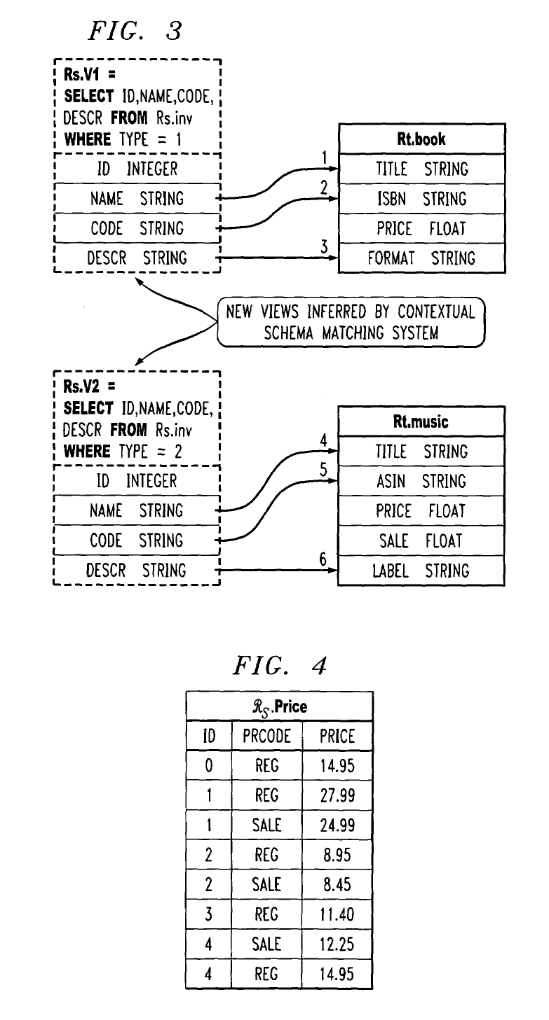

According to one aspect of the present invention, the notion of a contextual schema match is employed, in which each match is annotated with a logical condition providing the context in which the match should apply. In this example, matches 1-3 might be annotated with the condition type=1, while 4-6 should hold where type=2. Equivalently, one might think of views being introduced into the source or target schema to reflect a common context for several attribute matches, as shown in FIG. 3. FIG. 3 illustrates a contextual schema match for the inventory, books and music of FIG. 1.

Whenever one or more inheritance relationships are implicit in data, a database designer must choose, based on application needs, between placing the sub-types in separate tables or in a common table. This is a common-form of schema heterogeneity. The current retail inventory example shows one case of this, since “books” and “CDs” are sub-types of “inventory items,” but other examples abound: in one school's database both faculty and teaching assistants may appear in a single employee table, while in another school's database separate tables may be used, and similarly for conference and journal papers in a bibliography, apartments and houses in a real-estate database. Clearly, contextual schema matches directly eases the task of overcoming this form of schema heterogeneity.

Another important case where contextual matches are needed is that of “attribute normalization,” in which separate rows of one table correspond to different attributes in the same row of another table, as illustrated below. Consider supplementing the [symbol] _{S} table of FIG. 1 with the [symbol] _{S}.price table shown in FIG. 4. A standard schema matching tool might find only the matching: ( [symbol] _{S}.price.price→ [symbol] _{T}.music.price). However, a contextual match is more helpful, in which this match is conditioned on ( [symbol] _{S}.price.prcode=“reg”). Ideally, a second match ( [symbol] _{S}.price.price→ [symbol] _{T}.music.sale) would be discovered based on the context ( [symbol] _{S}.price.prcode=“sale”).

From these examples, it is clear that semantically correct conditions associated with matches increase the value of those matches to the user. The additional information helps the user construct a semantically correct mapping between R_{S} and R_{T}.

As indicated above, one aspect of the invention extends schema matching with contextual matching. According to another aspect of the invention, a general framework is defined for finding good contextual matches. A salient feature of this framework is that it treats schema matching largely as a black box, and thus can be used with any (instance-based) schema matching technique.

According to yet another aspect of the invention, techniques are disclosed for identifying good candidate conditions. One technique, TgtClasslnfer uses a classifier built on target attribute values while a second, SrcClassInfer depends only on internal features of a source table to identify promising conditions by rating some attributes on their ability to classify values of other attributes.

A further aspect of the invention defines filtering criteria for contextual match conditions. These filtering criteria are important since there are many possible contextual matches, and it is critical that, in addition to finding semantically correct contextual matches, a contextual matching algorithm does not confuse the user with too many false positives.

Contextual matches can be presented to an automated map generation algorithm, such as Clio (see, for example, L. Popa et al., “Translating Web Data,” VLDB (2002); and. L. Haas et al., “Clio Grows Up: From Research Prototype to Industrial Tool,” SIGMOD (2005)), in which the presence of contextual matches equates to the presence of views on the source or target table. In many cases, these views will be handled correctly by a Clio-style algorithm, but in general the joins necessary to construct the correct mapping for attribute normalization cannot be found with the standard rules.

Thus, according to one aspect of the invention, the definition of the key-foreign key relationship is extended so that contextual key-foreign key constraints are well-defined between views and either other views or base-tables. Rules for inferring some of these constraints based on the nature of the view are also disclosed.

New join rules are defined that, when added to Clio, allow automatic generation of a variety of mappings involving attribute normalization. This extended framework would also allow Clio to better cope with a standard schema match in which views were intentionally included by the user rather than inferred by a contextual schema matcher.

Some recent work has considered overcoming a variety of forms of schema heterogeneity automatically (see, G. H. L. Fletcher and C. M. Wyss, “Relational Data Mapping in MIQIS (demo),” Proc. of ACM SIGMOD Conf. on Management of Data, 912-914 (2005)), but takes a different search approach that requires common data instances to be represented in both schemas. In contrast, contextual schema matching is a direct extension of existing schema match technology. Much recent work has focused on matching in different data models, improving match quality by considering more fully the available information and maintaining mappings over time. In contrast, the present invention, like the inference of multi-attribute matches, expands the scope of schema matching in a way that allows greater automation of schema mapping than existing techniques. For a more detailed discussion of the recent work, see, Philip Bohannon et al., “Putting Context into Schema Matching,” VLDB (2006), incorporated herein by reference.

### Data Model and Non-Contextual Matching

Data and Match Model

Contextual schema matching is illustrated in the relational model.

A. Data Model

A schema (for example, [symbol] _{S} or [symbol] _{T}) is a collection of tables and views represented by the capital letter R (e.g. R_{S}, R_{T}). A table or view R has a set of attributes, att(R), represented by lower case letters a, s, t, l or h, or with the font AttributeName. An attribute has a type, type (a), drawn from (string, int, real, etc). Views considered herein are single-table selection views of the form V_{c}=“select * from R where c”, with selection condition c. Given an instance of R (a sample input), v(R.a) is used to denote the bag of values associated with attribute a in the instance, a shorthand for “select a from R”.

B. Matches

A match is a triple (R_{S}.s, R_{T}.t, c), where R_{S}ε [symbol] _{S}, R_{T}ε [symbol] _{T}, and c is a Boolean condition. Intuitively, it says that the pairing between attributes R_{S}.s and R_{T}.t makes sense if the condition c holds. A match is referred to as a standard match if c is “true” and R_{S} and R_{T} are base tables; otherwise it is called a context match. Thus, a standard match is a special case of context match. Some prior work considers “complex matches” in which multiple attributes are involved in a single match, but these are largely orthogonal to the issues presented herein, and such matches are not considered to simplify the presentation.

A list of “accepted” matches is referred to as [symbol] usually these are matches with a sufficiently high confidence. Note that [symbol] is an extension of what is referred to as a value correspondence to include matches to and from views.

C. Categorical Attributes

Informally, an attribute a is categorical if many of the values it takes are intended to be associated with several tuples in a full data set. In some cases, categorical attributes may be indicated by the schema, for example, by a constraint limiting the value to a fixed set of choices. However, in the absence of such information and with only a sample of the data available, the intent of attributes may be hard to discern. In this case, an attribute, a, is considered to be categorical if more than 10% of the values of a are associated with more than 1% of the tuples in the sample. In the case of small samples, at least two values must be associated with at least two tuples.

Context Complexity

The complexity of the conditions that can be associated with each view has a large effect on the difficulty of finding contextual matches. In developing matching schemes, it is useful to classify the view complexity by the number of attributes mentioned in its condition: a k-condition on relation R mentions exactly k attributes of R. A “simple” where condition is of the form a=v where a is an attribute and v is a constant, and is thus a 1-condition. Disjunctive, conjunctive, and general k-conditions generalize simple conditions in the usual way. The term “simple, disjunctive” refers to disjunctive 1-conditions, and can be written as a ε{v₁, v₂, vₖ}.

Standard Schema Matching Overview

The approach described herein for contextual schema matching is independent of the standard matching technology used, but a full understanding of the performance of the algorithms requires reference to the base matching algorithm's behavior. The disclosed base schema matching system employs a variety of matching algorithms, referred to as matchers, to compute similarity scores between a pair of attributes. These scores are weighted and for a single matcher m and source attribute a, the distribution of scores to all target attributes are treated as samples of a normal distribution, allowing the raw scores given by m for a to be converted into confidence score using standard statistical techniques. For a particular pair of attributes a and b, the confidences of all matchers are combined to compute the confidence of the match.

### Finding Contextual Matches

For simplicity, source contextual matches are considered below, although it is generally straightforward to reverse the role of source and target tables to discover matches involving conditions on the target table.

A. A Strawman Approach

A number of issues arise in contextual matching in terms of the following “strawman” approach to the problem: Consider a source relation R_{S} and a target relation R_{T}, and assume that a run of a standard match algorithm returned [symbol] =M₁ . . . Mₙ as the accepted matches between these relations. Let the average matcher score for M, be sᵢ, and the confidence assigned to that score be fᵢ. For some match Mᵢ=(R_{S}.s, R_{T}.t, true) and some condition c, consider replacing it with the match (R_{S}.s, R_{T}.t, c). To determine the value of using c, restrict the sample of R_{S} based on c, and re-evaluate the quality of the match between this modified sample and R_{T}.t. Let f_{c} be the confidence of this new match, which can be estimated using the new score s′ᵢ and the distribution of scores seen for R_{S}.s. Let δ_{c}=f_{c}−fᵢ be the improvement in Mᵢ for condition c. Now, given a space C of conditions on R_{S} (e.g., the simple equality conditions on categorical attributes of R_{S}), let cᵢ⁺ be the condition, if any, that maximizes δ_{c} subject to δ_{c}>0. If cᵢ⁺ exists, then (R_{S}.s, R_{T}.t, cᵢ⁺) is used in place of Mᵢ.

B. Significance

Unfortunately, the strawman approach will almost always find some condition which improves the match confidence, even when the original, unconditioned match is semantically correct but the new match is not. Too see why, consider taking random subsets of the sample associated with R_{S}.s, and scoring the match (normalized for the size of the subset) with R_{T}.t. It is clear that there will always be a random subset that yields an above average score (unless all scores are equal). Thus, even if there are no semantically valid contextual matches between R_{S} and R_{T}, the strawman is still likely to find meaningless conditions for each match, and the output will be confusing to the user rather than helpful.

C. False Negatives

A secondary issue with the strawman approach is the potential for false negatives: semantically valid contextual matches that do not correspond to any of the matches M₁ . . . Mₙ returned by the original match algorithm. The potential for false negatives was illustrated by the sale attribute in the above retail inventory example.

D. Conditions as Views

The first step to avoid insignificant matches is to set an improvement threshold for accepting a condition, so that just being above average is not sufficient. Unfortunately, setting a threshold for a single match condition is problematic. Even if the threshold is set so that it will only be crossed by a random attribute pair a small percent of the time, if enough random conditions are tried, there is still a significant chance that one of them will pass the threshold. On the other hand, it is also possible that a semantically correct condition will not pass the threshold, and hence be overlooked.

A better approach is to require that a single condition c be found for the whole table R_{S}, and count the total improvement across all of the individual matches. Based on the assumption that semantically valid conditions will improve several matches, it is more likely for a valid improvement to surpass a given threshold. For semantically invalid conditions, however, the improvement in different matches is less likely to be correlated, and hence the total improvement should be small.

Since the quality of a condition c needs to be evaluated across multiple attributes, it makes sense to think of conditions at the table level rather than at the attribute level. Accordingly, it makes sense to think of each candidate condition c on table R_{S} as defining a ‘select-only’ view, V_{c}, on R_{S}. This terminology is convenient, as it permits a discussion of the quality of the match between V_{C} and some target table. Since some schemes consider a large number of candidate conditions, it is important to emphasize that views are not created in the DBMS storing [symbol] _{S} or [symbol] _{T} during the search process.

Finding Contextual Matches

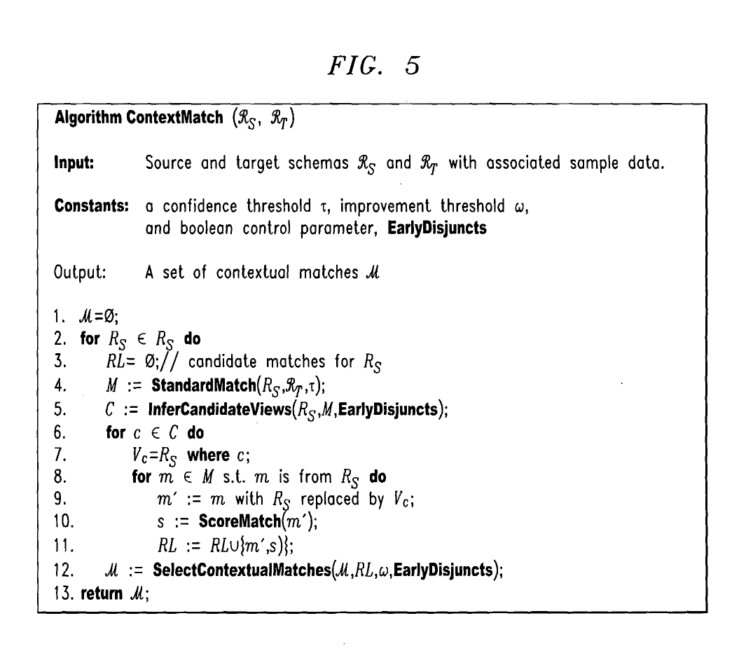

The overall approach to finding contextual matches is shown as the algorithm ContextMatch in FIG. 5. Alternative implementations of the functions called by ContextMatch are developed in the remainder of this section.

The goal of the ContextMatch algorithm is to assemble in [symbol] a collection of high quality source contextual matches. To accomplish this, algorithm ContextMatch considers each source table R_{S} in turn at line 2, and generates a list of prototype matches between R_{S} and tables in the target schema by taking the output of a standard schema match algorithm StandardMatch. In this call, the quality threshold imposed by StandardMatch on returned matches is shown as a parameter τ. Note that by reducing τ, the risk of false negatives is reduced at the cost of greater time spent in ContextMatch.

Next, based on some underlying space of contextual conditions (usually the 1-conditions of the source tables), a set of candidate view conditions, C, is generated by the function InferCandidateViews. A variety of possible implementations are considered for InferCandidateViews below. Further, the behavior of InferCandidateViews with regard to disjunctive conditions is controlled by EarlyDisjuncts, as described below. Note that no conditions will be returned if [symbol] is empty.

In lines 8-11, the algorithm evaluates contextual matches based on each of the conditions in C. The routine ScoreMatch evaluates the quality of each match m′ between V_{c} and R_{T}. This function is provided by a standard instance-based schema matching system, but considers only the subset of sample data for R_{S} meeting c. Note that a match is scored only if it is a conditional version of one of the matches returned by StandardMatch. Finally, SelectContextualMatches is called to determine the matches (and thus the conditions) to return to the user as the output of the schema matching process. This is described in more detail below.

Selecting Views to Evaluate

In this section, the condition pruning policy is described as defined by an exemplary implementation of InferCandidateViews. Initially, a naive approach is discussed, and then novel techniques designed to filter out conditions that are unlikely to improve match scores are presented. The key idea behind all three techniques is that a family of views should be created whenever the data values of some non-categorical attributes are well-classified by a categorical attribute.

A. A Naive Approach

The NaiveInfer approach infers views on a schema as follows: for every table R, and every categorical attribute lεCat(R), a set of views is created. For simple context, a view Vᵢ=“select * from R where l=vᵢ” is added to the set of returned views for every value vᵢ of l in the sample data. If simple-disjunctive views are considered, a set of views is created for every partitioning of the vᵢ values. This approach may work reasonably well for simple context if there are relatively few categorical attributes.

B. Well-Clustered View Families

A view family F=(R, l, {Vᵢ} is defined as a set of select-only views {Vᵢ}, based on mutually exclusive boolean conditions over only one attribute, l. A view family F effectively partitions the tuples of a table R into a set of views based on values of a categorical attribute l. For example, in FIG. 1(a), a view family on the attribute type would consist of two views, dividing the tuples based on whether type=1 or type=2. Intuitively, F is of higher quality if the tuples are well-clustered, that is, if for some other attribute h, the t.h values are more similar within a view than between views. In the example, this means that other attributes, like code or descr, are more similar for tuples with the same value for type than for tuples with different values.

This intuitive quality is formalized into a metric based on machine-learning techniques for categorization, and illustrate how it is applied to find good candidate conditions in Algorithm ClusteredViewGen of FIG. 6. On line 1, the algorithm considers a non-categorical attribute h, and a categorical attribute l, taking on values v₁, v₂, . . . v_{γ} in the sample data. The idea of the algorithm is to consider the values taken by h to be “documents” to be classified, the vᵢ values in the sample data to be classification labels, and the tuples to be the “expert assignment” of labels to documents. Two subsets of the sample tuples of R are then considered, one for training and one for testing. In doTraining at line 2, a single-label classification function Cₕ is developed based only on the training data. (The implementation of Cₕ differs, but one might think of a Naive Bayes classifier on tokens or Q-grams.)

Next, in doTesting, the function Cₕ is presented with unseen testing data, and the quality of Cₕ is assessed in a standard way as the combined, micro-averaged, precision and recall of Cₕ according to the standard F_{β} function with β=1. If the quality is good enough, as described below, the family of views {Vᵢ|iε[1,γ]} (where Vᵢ is conditioned on l=vᵢ) is considered to be well-clustered, and add it to the return list at line 6.

C. Score Significance

Precision and recall are traditionally used as a quality metric for the classifier Cₕ, compared to other classifiers, but instead the extent to which h is correctly classified by l is scored. It is determined if Cₕ classifies the testing data correctly, and also if the number of correct classifications are significant. Accordingly, the null hypothesis is considered that there is in fact no correlation between h and l, and instead values of l are just chosen randomly, proportional to their frequencies in the training data. Cₕ is compared to a naive classifier, C_{Naive}, which always chooses the most common value of l as the label, regardless of h. The number of correct classifications by C_{Naive} under the null hypothesis is a binomial distribution, with

$$p = \frac{\vert {v}^{*} \vert}{{n}_{train}} .$$

### Its expected score μ is nₜₑₛₜp, and the standard deviation σ is \sqrt{nₜₑₛₜp(1−p)}. The likelihood of the null hypothesis is therefore

$$1 - Φ ( \frac{c - μ}{σ} )$$

(where Φ is the normal CDF). If the inverse of this likelihood is above a threshold T (typically 95%), the alternative hypothesis that l can be predicted by h is accepted, and include simple conditions on I in the result of GenCandidateMatches.

Two ways are presented to define Cₕ, leading to two algorithms for inferring well-clustered view families: SrcClassInfer, and TgtClassInfer.

C. Inferring Candidate Views with SrcClassInfer

A first approach is the simplest one naturally suggested by the previous discussion: namely, train a classifier Cₕ on the values of h in the source table. Specifically, for each tuple t in the training data, Cₕ is trained on t.h→t.l. If h is a text attribute, a standard Naive Bayesian classifier is used, with the values tokenized into 3-grams. If h is a numeric attribute, a statistical classifier is used instead.

D. Inferring Views with TgtClasslnfer

Unlike SrcClassInfer, TgtClasslnfer attempts to classify elements of h based on information gleaned from the target tables. It tags individual data values in [symbol] _{S} based on attributes of [symbol] _{T} to which it is most similar. For example, assume it recognizes that some titles in [symbol] _{S}.inv are most similar to titles in [symbol] _{T}.book. It will tag those tuples with Book.Title. Furthermore, assume it recognizes that other elements of the same column are most similar to titles in [symbol] _{T}.music. It will tag those tuples with Music.Title. doTraining will then attempt to learn an association between these tags and the categorical attributes in l. While only inferring views on source relations are considered, this approach can be used to infer views on target relations by simply reversing the roles of [symbol] _{S}.and [symbol] _{T}.

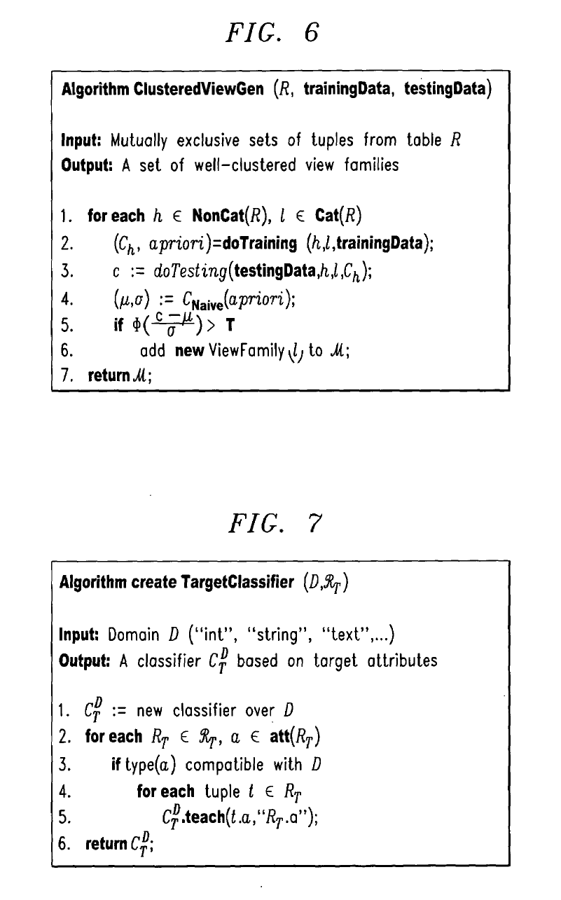

TgtClasslnfer maintains separate classifiers CD for every basic type D (e.g. “int”, “string”, etc.). These classifiers are created by the procedure createTargetClassifier (D, [symbol] _{T}) (shown in FIG. 7), which also trains them on the data in the target schemas. (Note that this is different than the training that occurs in ClusteredViewGen.) These classifiers essentially attempt to guess the column that any given sample should appear in. For example, if the target schema contained the tables Book and Music, which each only had the single attribute Title, then a classifer C_{T}^{String} would be created which, when given a String, would return either Book.Title or Music.Title.

The next step is to apply these classifiers to the source table. In doTraining in ClusteredViewGen, TBag(R_{S}.h, R_{S}.l) is created by collecting the bag of pairs (g, v) for each tuple t in trainingData, s.t. g is the tag C_{T}^{D}.classify (t.h), and v=t.l. In other words, given a tuple t, doTraining attempts to learn an association between t.l and C_{T}^{D}.classify (t.h). For example, if tuple with id 2 in [symbol] _{S}.inv is considered with type=1 and name=“lance armstrong's war”, and C_{T}^{D}.classify (“lance armstrong's war”) returns Book.Title, then the pair (Book.Title, 2) will be included in TBag (Rₛ.name, Rₛ.type).

In doTesting, TgtClasslnfer must return a category vᵢ for every t.h provided to it. It accomplishes this in the following manner. Given TBag, accuracy and precision are defined in the usual way between g and v, by treating each (g,v) pair as an occurrence and computing acc(g,v)=P(g|v) and prec(g,v)=P(v|g). These two are combined to produce the score(g,v)=acc(g,v)·prec(g,v). The “best” categorical attribute value, bestCAT(g), is computed as the value v that maximizes score(g,v). Ties are broken in favor of the value v that is more common. In the case of a continued tie (or when g was never encountered during training), an arbitrary categorical value is selected for g and returned. Given this infrastructure, during doTesting, the overall TgtClasslnfer classifier will return:

vᵢ=bestCAT (C_{T}^{D}.classify (t.h))

Handling Disjunctive Context

Another dimension to finding matching conditions is the treatment of disjunction. The simplest approach is to exclude disjunctive conditions from condition selection, and then to union together the high-scoring conjunctive views. An alternative approach is to allow conditions with disjunctions in C, and attempt to find the single best condition. This alternative approach is early disjunction handling, and is taken when EarlyDisjuncts=true. Because the number of disjunctive conditions grows exponentially in the cardinality of the categorical data, it is critical to prune the disjunctive conditions that are considered.

Techniques for extending SrcClassInfer and TgtClassInfer for EarlyDisjuncts to infer well-clustered views on disjunctive simple conditions are now described. In other words, conditions of the form S.lε{v₁, v₂, . . . , vₖ}. The algorithm is a simple extension of ClusteredViewGen based on errors in classification, and is not shown. Errors take the form (v, v′) where for some tuple t, t.l=v, but the classifier returned v′ when presented with t.h. False positives and false negatives are not distinguished, so (v′, v) is grouped together with (v, v′). To build disjunctive conditions, the pair (v, v′) that appears most often as an error during testing is noted (after normalizing for the frequency of v and v′). Consider merging v and v′; that is, replace all occurrences of either value in S.l with a new token pair (v, v′). Repeat the training and testing process, and if the new view family containing the view t.l=v or t.l=v′ has high quality, it is added to the return list. Regardless of whether a new view family is successfully formed, this process is repeated until either there are no errors during testing, or there are no more categorical values to merge. While it may be worthwhile to consider other techniques, this approach works well and is quite efficient.

Selecting Contextual Matches

The set of contextual matches [symbol] returned from ContextMatch will likely be large. There may be many matches returned from GenCandMatches (depending on the value of τ), and then the number of those matches are then multiplied by the number of views created by InferCandidateViews. In order to avoid overwhelming the user with possible match candidates, SelectContextualMatches is implemented to attempt to find a small, coherent subset for presentation to the user.

Consider two techniques for SelectContextualMatches. The simplest technique is to find the single match with highest confidence for every target attribute. Note that this technique will allow a target table to have matches from many different source tables. This technique is referred to as MultiTable.

Instead of selecting the best matches on a per-attribute basis, a second approach is to select the best matches on a per-table basis. This technique, called QualTable, considers each target table R_{T} in turn. It selects the source table R_{S} which maximizes the total confidences of all matches in [symbol] that are between R_{S} and R_{T}. It then considers each candidate view V_{c} of R_{S}. If the total confidences in the matches between V_{c} and R_{T} improves the base confidence between R_{S} and R_{T} by at least an improvement threshold ω, then V_{c} is used instead of R_{S}. If multiple candidate views improve the base confidence by at least (, then the set of views selected is based on EarlyDisjuncts. Selecting multiple candidate views is analogous to disjuncting over those views. If EarlyDisjuncts=true, disjunctive conditions are allowed in the view, and so only the single best candidate view is selected. If EarlyDisjuncts=false (also referred to as LateDisjuncts, then all candidate views that exceed ω are selected. (Note that while ω affects both EarlyDisjuncts and LateDisjuncts, it has a much larger role for LateDisjuncts.) Finally, the matches between the selected views and the target tables are returned.

A. Strawman Revisited

It is noted that the behavior of the strawman approach to contextual matching described previously can be obtained in this framework by using NaiveInfer for InferCandidateViews, and MultiTable for SelectContextualMatches.

Handling Conjunctive Conditions

The algorithms discussed above have handled simple conditions and disjunctive conditions. However, conjunctive conditions might also be involved in contextual matches. For example, the Books target table might instead be semantically Non-fiction-Books, and the correct match from the inventory table might require a condition of the form “type=1 and fiction=0.” The algorithms as given so far cannot find this condition. Handling conjunctive conditions is potentially a problem, due to the obvious exponential explosion in the number of conditions that must be considered. To deal with this, a NaiveInfer that enumerates conjunctive conditions is not attempted. Rather, a heuristic approach assumes that a high-quality k-condition has at least one high-quality k−1-sub-condition.

ContextMatch is executed repeatedly. At stage i, the algorithm will have found views involving i-conditions. At stage i+1, InferCandidateViews is restricted so that a) only views created during the i'th run are considered as base tables that might need partitioning, and b) when generating candidate subsets of a “base table” V_{c}, only attributes not in c are allowed to participate in the partitioning. In the example given above, the correct condition can be found in the second iteration as long as one of the sub-conditions, either “type=1” or “fiction=0” is found in the first iteration. While this algorithm can potentially find k-conditions for any k, it is submitted that very few, say 2 or 3, iterations will be practically useful.

### Extending Schema Mapping for Views

In this section, the challenges to standard schema mapping raised by the presence of contextual matches in, [symbol] the output of the schema matcher are addressed. Such matches are treated as introducing select-only views into the schema mapping process. To this end, the schema mapping approach of Clio is extended to accommodate contextual conditions (views). Since a fundamental concept in Clio is the formation of logical tables based on key-foreign key relationships, the definition of these relationships and rules for building logical tables must be extended to handle views. A form of foreign keys is proposed herein to capture semantic connection between views and base tables. Inference rules are provided for constraint propagation analysis. New rules are posed for joining semantically related attributes in views and base tables. As a result of these rules, mapping queries can be correctly inferred involving attribute normalization, demonstrating an important synergy between contextual schema matching and the subsequent schema mapping process.

Standard Schema Mapping (Clio)

Schema mapping is concerned with turning value correspondences (matches) into mapping queries from source tables to target tables. Formally, the schema mapping problem can be stated as follows: Given a collection [symbol] of matches (R_{S}.a, R_{T}.b, conf), source schema [symbol] _{S} and target schema [symbol] _{T}, find a mapping map: [symbol] _{S}→ [symbol] _{T} such that for any instance I of [symbol] _{S}, map(I) is an instance of [symbol] _{T}.

In the absence of contextual conditions, the problem of finding schema mapping based on value correspondences has been well studied. In particular, it constitutes one of the key modules of Clio. Central to generating a schema mapping is how to join tables together based on schema matches found and their semantic associations, such that semantically related attributes can be mapped from source to target in groups to preserve their logical connections. Previous approaches depend on foreign keys to guide the semantic associations (joins).

Although Clio handles a more powerful nested relational model, a restriction of this method to relational data is referred to as “the Clio approach.” In a nutshell, a mapping map( ) in (relational) Clio is the collection of individual map ( [symbol] _{S}, R_{T}) ( ) queries for each target table R_{T}ε [symbol] _{T}. For a particular R_{T}, map ( [symbol] _{S}, R_{T}) ( ) is constructed as a union of logical tables as follows: (a) With respect to a target table R_{T} and a source table R_{S}, a logical table R_{S,T} is formed as R_{S} plus a set of other tables that also have matches to R_{T} and that are reachable from R_{S} in [symbol] _{S} using a pattern of joins defined by certain semantic association rules. (b) It interprets value correspondences as inter-schema inclusion dependencies from the source to the target. (c) For each logical table R_{S,T}, it defines a query map ( [symbol] _{S}, R_{T}) ( ) that, given any instance tuple tₛ of R_{S}, generates a tuple t_{T} of R_{T} by mapping the value of the attributes in R_{S} to the value of the corresponding attributes in R_{T} via the related inclusion dependencies. For those attributes in t_{T} that are not related to any attributes in t_{S} via the inclusion dependencies (i.e., these values in the target are not represented in the source), Skolem functions are used to generate non-null values based on the known values of t_{T} mapped from t_{S}. For those attributes in t_{S} that are not mapped to any attributes in t_{T} (i.e., these source values are not represented in the target) their values are omitted. (d) Finally, map ( [symbol] _{S}, R_{T}) (is defined as the union over all logical tables R_{S,T} of source attributes with value correspondences targeting R_{T}.

Clio adopts two semantic association rules to group attributes together: (a) attributes from the same table are associated with each other; and (b) attributes from different tables are associated using foreign keys, i.e., if table R₁ is in a logical table, and if there is a foreign key in a table R₁ referencing another table R₂, then R₂ can be added with an outer-join between the foreign key and the key is conducted to group attributes in R₁ and R₂ together. The constraints are either declared in the definition of the schema, or discovered using constraint mining tools. In order to identify all meaningful joins, the closure of these constraints is computed using an extension of the standard chase method. While the chasing process may not terminate for the class of constraints involved, the Clio experience verified that it is an effective method in practice.

Constraint Propagation from Base Tables to View

Keys and foreign keys on views are derived from their base table counterparts. While constraints are declared or discovered at the base-table level, to determine joins between views and/or base tables one needs keys and foreign keys on views. This requires reasoning about constraint propagation from base tables to views.

A. Keys and Foreign Keys

Consider a relational schema [symbol] and a class E of constraints defined on [symbol] Let R₁, R₂ be two relational schemas in [symbol] The constraints in Σ have the following forms.

(a) Key: φ=R₁[X]→R₁, where X⊂att(R₁). The key holds on an instance I₁ of R₁ if for any tuples t₁, t₂ in I₁, if t₁[X]=t₂[X], then t₁=t₂, i.e., the X attributes of a tuple t uniquely identify t in I₁.

(b) Foreign key: φ=R₂[Y]⊂R₁[X], where Y is a list of attributes in att(R₂), and X is a list of attributes in att(R₁) and is a key of R₁. The foreign key holds on instances I₁, I₂ of R₁, R₂ if for any tuple t₂ in I₂, there exists a tuple t₁ in I₁ such that t₂[Y]=[X]; in other words, the Y attributes of t₂ reference the t₁ tuple in I₁.

B. Contextual Constraints on Views

For constraints on views, the definitions of keys and foreign keys given above are extended by allowing R₁, R₂ to be either base tables or views, e.g., a foreign key of a view referencing a base table or view is allowed.

Let V₁ be a view defined on R₁ via a SP query Q₁. A contextual foreign key of V is an expression V₁[Y, a=v]⊂R[X,b], where (a) Y is a list of attributes in att(V₁), (b) a is an attribute in R₁ but is not in att(V₁) (i.e., a is not on the projection list of Q₁), (c) a=v is the selection condition of Q₁, (d) R is either a base table or a view and (e) [X, b] is a key of R. The constraint holds on instances I₁, I of R₁, R if for any tuple t₁ in Q₁(I₁), there exists a tuple t in I such that t₁[Y]=t[X] and t[b]=v. In other words, the Y attributes of V₁ augmented with a constant v as the value of a is a foreign key referencing R tuples. As will be seen shortly, contextual constraints are important for semantic association of attributes from views and base tables. No previous work has studied this form of constraints.

Consider a schema [symbol] _{S} consisting of base tables:

student (name: string, email: string, address: string),

project (name: string, assignt: int, grade: char, instructor: string),

where keys are underlined. The project relation indicates that a student (name) gets grade for a project assignt under the instructor. Suppose that the schema matcher finds that assignt ranges over [0,9] and defines views Vᵢ on project via SP query Qᵢ, for iε[0,9]:

select name, grade from project where assignt=i

then Vᵢ[name, assignt=i]εproject[name, assignt] is a contextual foreign key of view Vᵢ referencing the base table project. Note that assignt is not an attribute of the view Vᵢ.

C. Constraint Propagation
Consider a collection V of views defined on [symbol] via SP queries Q. A constraint ψ on the views V is propagated from Σ via Q, if for any instance I of [symbol] if I satisfies Σ then Q(I) satisfies ψ.

The constraint propagation problem is to determine, given Σ, [symbol] and Q, whether a key or (contextual) foreign key is propagated from Σ via Q. While the problem has been studied for functional and multi-value dependencies, it has not been considered for keys and (contextual) foreign keys of the above forms.

The following theorem below indicates that the propagation analysis of keys and foreign keys is beyond reach. The key and foreign key propagation problem is undecidable for views defined in terms of SP queries.

Thus, two methods are used to find constraints on views propagated from base tables. (a) Constraint mining tools are employed on sample data to discover keys and (contextual) foreign keys on views, as Clio does for finding keys and foreign keys on base tables. (b) A set of sound (but by no means complete) inference rules are proposed for the propagation analysis.

Let V₁ be a view defined on R₁ via a SP query Q₁, and X be attributes in att(V₁). Then the following indicates that X is a key of V₁ under certain conditions.

Contextual propagation. If R₁[X,a]→R₁, i.e., [X,a] is in a key on R₁ and a=v is the selection condition of Q₁, then V₁[X]→V₁, i.e., the values of X attributes suffice to uniquely identify a V₁ tuple.

Assume that R is either a view or a base table, and that R[Y]→R is a key. Then X is a (contextual) foreign key of V₁ referencing Y of R if one of the following conditions holds.

View-referencing. If R₁[X]→R₁, X⊂att(V₁), aεX, the selection condition of Q₁ is a=vₗ or . . . or a=vₙ, and the domain of a is exactly {vₗ, . . . , vₙ}, then R₁[X]⊂V₁[X].

Contextual constraint. If R₁[X,a]→R₁ and the selection condition of Q₁ is a=v, then V₁[X,a=v]⊂R₁[X,a] is a contextual foreign key of V₁ referencing R₁.

Recall the above schema [symbol] _{S} with the base tables student and project. For each view Vᵢ, Vᵢ[name]→Vᵢ can be derived from the set of keys on [symbol] _{S} using the rule contextual propagation, and the contextual foreign keys given in the above example are derived using the rule contextual constraint. Furthermore, if project[name]⊂student[name] is a foreign key on [symbol] _{S}, then one can derive Vᵢ[name]⊂student[name] as a foreign key of the view Vᵢ referencing base table student, using a rule FK-propagation.

### Semantic Associations of Attributes

Attributes in different views and/or base tables can be grouped together based on their logical relations. This is important for generating schema mapping queries. To this end, new semantic association rules are proposed beyond those used in Clio.

Along the same lines as Clio, (a) attributes from the same base table or view, (b) attributes from different tables or views that are related via an outer-join on foreign keys, which are derived by the propagation analysis and mining given above are associated. However, additional association rules need to be considered in order to capture important schema mapping in the presence of contextual conditions in the view definitions, as illustrated by the example below.

Consider a target relational schema [symbol] _{T}

projs(name: string, assignt₀: int, grade₀: char, . . . , assignt₉: int, grade₉: char).

Here the projs relation groups, in the same tuple, different assignts of the same student by name. Suppose that the contextual schema matcher finds a conditioned partition that for iε[0,9], maps Vᵢ.name to projs.name and Vᵢ.grade to projs.gradeᵢ, where Vᵢ is the view given in the above example. Intuitively, to map the source data in the views to the target, one needs to group together the ten views by (outer-) joins on the key name. However, this grouping cannot be derived by using the two association rules given above since there is no foreign keys between those views involved.

This motivates the following association rule:

(join 1). Suppose that V₁, V₂ are views defined in terms of SP queries Q₁, Q₂ on the same attributes of the same base table R, i.e., Qᵢ is select Y from R where a=vᵢ, for iε[1,2] and v₁≠v₂. If via propagation analysis we can derive, for iε[1,2], (a) keys Vᵢ[X]→Vᵢ and (b) (contextual) foreign keys Vᵢ[X, a=vᵢ]⊂R′[Z] for some relation R′ and Z⊂att(R′), then we group attributes of V₁, V₂ together via join between V₁ and V₂ on the key X. In a nutshell, the propagated constraints ensure that it is to associate different properties of the same object.

From rule (join 1) and the constraint propagation analysis of the above example, a mapping is derived from the joins of the ten views Vᵢ to the target table [symbol] _{T} as described in the above example.

For views defined on different attributes of the same table, the following association rule is needed.

(join 2). Suppose that V₁, V₂ are views defined in terms of SP queries Q₁, Q₂ on different attributes of the same base table R, i.e., Qᵢ is select Yᵢ from R where condᵢ, where Y₁ and Y₂ are not the same set of attributes. If via propagation analysis we can derive (a) keys Vᵢ[X]→Vᵢ for iε[1,2], where X is a subset of both Y₁ and Y₂, (b) (contextual) foreign keys Vᵢ[X, a=v]⊂R′[Z] for some relation R′ and Z⊂att(R′), and moreover, (c) cond₁ and cond₂ are the same condition a=v, then we group attributes of V₁, V₂ together via join between V₁ and V₂ on the key X. Here condition (c) is to avoid associating properties of different objects.

Recall the above schema [symbol] _{S} and consider a different set of views Uᵢ on [symbol] _{S} for iε[0,9]:

select name, instructor from project where assignt=i

The rule (join 2) indicates that the join of Vᵢ and Uᵢ on name is meaningful. However, it is not logical to join Vᵢ and Uⱼ if i≠j.

(join 3). Suppose that V₁ is a view and R is either a view or a base table. If V₁[Y, a=v]⊂R[X, b] is a contextual foreign key, then we can group attributes of V₁ and R together via an outer-join from V₁ to R on the equality between X of V₁ and Y of R, with b=v. This is a mild extension of Clio join rules, and it is based on contextual foreign keys instead of foreign keys.

The association rules of Clio are also used in the system to group attributes of views and/or base tables via outer-join on foreign keys. Observe that (join 1), (join 2) and (join 3) are introduced to capture the contextual conditions (views) that are not encountered in Clio. With the inclusion of these rules, the output of contextual schema matching can be smoothly incorporated in Clio to not only find simple contextual mappings, but also to infer sophisticated attribute normalizations.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for mapping at least one source table to at least one target table, comprising:
generating a list of matches between said at least one source table and said at least one target table; and
annotating one or more of said matches with a logical condition providing a context in which said match applies.

2. The method of claim 1, wherein said annotating step further comprises the step of generating a set of candidate view conditions, C, to be applied to said one or more source tables, wherein said candidate view conditions, C, provide said context in which a corresponding match applies.

3. The method of claim 2, further comprising the step of evaluating contextual matches based on said candidate view conditions, C.

4. The method of claim 3, wherein said evaluating step further comprises the step of evaluating a quality of each match between a view and said at least one target table.

5. The method of claim 1, further comprising the step of determining one or more of said matches to return to a user.

6. The method of claim 1, wherein said step of generating a list of matches is performed by a schema match algorithm.

7. The method of claim 1, wherein said step of generating a list of matches employs a quality threshold τ.

8. The method of claim 1, wherein candidate logical conditions are identified by creating a set of views for categorical attributes in said tables and adding a view for each partitioning of the values of the attributes in said tables.

9. The method of claim 1, wherein candidate logical conditions are identified by using a classifier built on target attribute values.

10. The method of claim 1, wherein candidate logical conditions are identified by evaluating internal features of a source table to identify candidate logical conditions by rating one or more attributes on an ability of said one or more rated attributes to classify values of other attributes.

11. The method of claim 1, further comprising the step of inferring one or more contextual key-foreign key constraints using rules based on the nature of the view.

12. The method of claim 1, further comprising the step of automatically generating a plurality of mappings involving attribute normalization.

13. An apparatus for mapping at least one source table to at least one target table, the apparatus comprising:
a memory; and
at least one processor, coupled to the memory, operative to:
generate a list of matches between said at least one source table and said at least one target table; and
annotate one or more of said matches with a logical condition providing a context in which said match applies.

14. The apparatus of claim 13, wherein said processor is further configured to generate a set of candidate view conditions, C, to be applied to said one or more source tables, wherein said candidate view conditions, C, provide said context in which a corresponding match applies.

15. The apparatus of claim 14, wherein said processor is further configured to evaluate contextual matches based on said candidate view conditions, C.

16. The apparatus of claim 15, wherein said processor is further configured to evaluate a quality of each match between a view and said at least one target table.

17. The apparatus of claim 13, wherein candidate logical conditions are identified by one or more of (i) creating a set of views for categorical attributes in said tables and adding a view for each partitioning of the values of the attributes in said tables; (ii) using a classifier built on target attribute values; and (iii) evaluating internal features of a source table to identify candidate logical conditions by rating one or more attributes on an ability of said one or more rated attributes to classify values of other attributes.

18. The apparatus of claim 13, wherein said processor is further configured to infer one or more contextual key-foreign key constraints using rules based on the nature of the view.

19. The apparatus of claim 13, wherein said processor is further configured to automatically generate a plurality of mappings involving attribute normalization.

20. An article of manufacture for mapping at least one source table to at least one target table, comprising:
a computer readable medium having computer readable code means embodied thereon, said computer readable program code means comprising:
a step to generate a list of matches between said at least one source table and said at least one target table; and
a step to annotate one or more of said matches with a logical condition providing a context in which said match applies.
